(19) United States
(12) Patent Application Publication
(10) Pub. No.: US 2025/0309452 A1
(43) Pub. Date: Oct. 2, 2025

(54) COVER STRUCTURE AND BATTERY PACK

(71) Applicant: EVE ENERGY CO., LTD., HUIZHOU (CN)

(72) Inventors: XIANGSHENG LIU, HUIZHOU (CN); WENCONG QIU, HUIZHOU (CN)

(21) Appl. No.: 18/977,927

(22) Filed: Dec. 12, 2024

(30) Foreign Application Priority Data
Mar. 30, 2024 (CN) 202420653734.9

(51) Int. Cl. H01M 50/271; H01M 50/233

(52) U.S. Cl. CPC H01M 50/271; H01M 50/233

(57) ABSTRACT

A cover structure and a battery pack employing the cover structure are provided. The battery pack further includes a plurality of cells and a box. The cover structure includes a substrate and an exhaust portion. The substrate is configured to cover the box. The substrate and the box together form an accommodating cavity to accommodate the plurality of cells and foam adhesive arranged along a plurality of adhesive injection tracks preset in the accommodating cavity. The exhaust portion is provided on a middle portion of the substrate. The exhaust portion is provided with a plurality of exhaust holes. An area between two adjacent adhesive injection tracks corresponds to at least one of the exhaust holes.

### CROSS-REFERENCE TO RELATED APPLICATION

The present disclosure claims priority to Chinese Patent Application No. 202420653734.9, filed on Mar. 30, 2024, the disclosure of which is incorporated herein by reference in its entirety.

### TECHNICAL FIELD

The present disclosure relates to the technology field of batteries, and in particular, to a cover structure and a battery pack.

### BACKGROUND

Batteries are usually packaged into a battery pack by means of encapsulating foaming technology, which can prevent batteries from being affected by dust, temperature and humidity; reduce the risk of the batteries being affected by moisture, corrosion and short circuit; dissipate internal heat of the batteries to improve the safety of the battery; and help in shock absorption and prolong the service life of the batteries.

In related technologies, for fully encapsulated foaming battery packs, there are usually many bubbles left on an inner side of a box cover during a foaming process that cannot be discharged, which can easily form vacuolar zones in the region where the bubbles are left. The vacuolar zones may directly affect the adhesive performance of the box cover, leading to a reduction in the overall strength of the battery pack.

### SUMMARY

In a first aspect, the present disclosure provides a cover structure employed in a battery pack. The battery pack further includes a plurality of cells and a box. The cover structure includes a substrate and an exhaust portion. The substrate is configured to cover the box. The substrate and the box together form an accommodating cavity, and the accommodating cavity is configured to accommodating the plurality of cells and foam adhesive arranged along a plurality of adhesive injection tracks preset in the accommodating cavity. The exhaust portion provided on a middle portion of the substrate. The exhaust portion is provided with a plurality of exhaust holes. An area between two adjacent adhesive injection tracks corresponds to at least one of the exhaust holes.

In a second aspect, the present disclosure provides a battery pack including a plurality of cells, a box and the cover structure provided in the first aspect of the present disclosure. The cover structure and the box together form the accommodating cavity. Each cell is provided in the accommodating cavity, and foam adhesive is provided in the accommodating cavity.

### BRIEF DESCRIPTION OF THE DRAWINGS

FIG. 1 is a top perspective schematic diagram of a battery pack according to some embodiments.

FIG. 2 is a structural schematic diagram of a cover structure viewed from a first perspective according to some embodiments.

FIG. 3 is a structural schematic diagram of a cover structure viewed from a second perspective according to some embodiments.

FIG. 4 is a schematic diagram of the structure at region A as shown in FIG. 3.

FIG. 5 is a structural schematic diagram of another cover structure according to some embodiments.

FIG. 6 is a top perspective schematic diagram of another battery pack according to some embodiments.

### REFERENCE NUMERALS IN THE DRAWINGS

1, battery pack; 10, cover structure; 100, substrate; 200, exhaust portion; 210, exhaust region; 212, exhaust hole; 213, second marking line; 300, fixing portion; 310, fixing hole; 400, cell; 500, adhesive injection track; 600, box; 61, accommodating cavity; 611, accommodating region; X, central axis.

### DETAILED DESCRIPTION

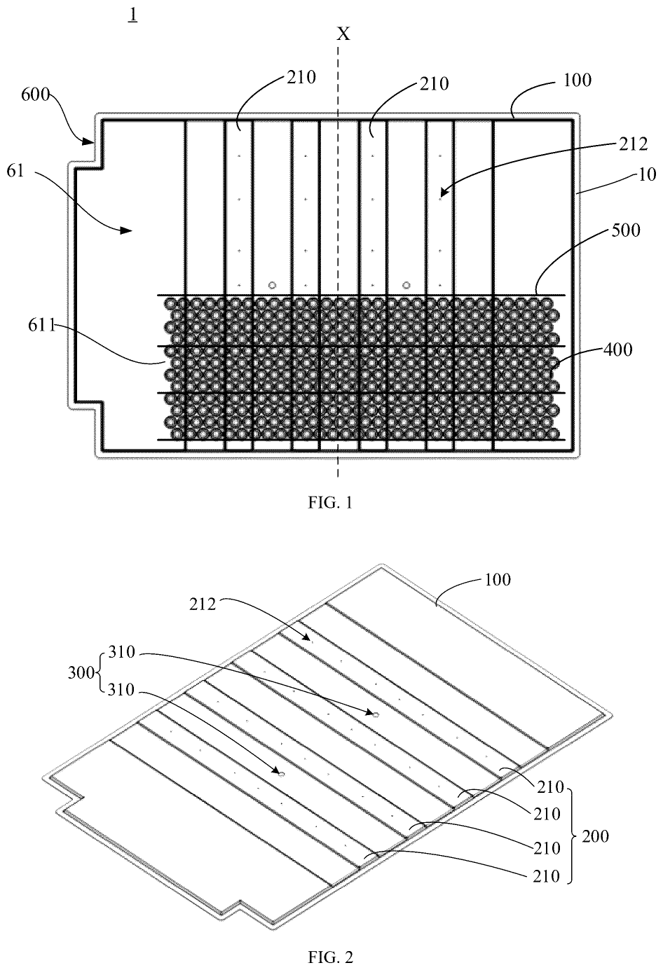

In some embodiments, as shown in FIG. 1 and FIG. 2, a cover structure 10 and a battery pack 1 employing the cover structure 10 are provided. The battery pack 1 further includes a plurality of cells 400 and a box 600. The cover structure 10 covers the box 600, and forms an accommodating cavity 61 together with the box 600. Specifically, the cover structure 10 includes a substrate 100 and an exhaust portion 200. The substrate 100 is configured to cover the box 600, and form the accommodating cavity 61 together with the box 600. The box 600 is preset with a plurality of adhesive injection tracks 500 in an bottom of the accommodating cavity 61. The accommodating cavity 61 is configured to accommodate the plurality of cells 400 and foam adhesive arranged along the plurality of adhesive injection tracks 500. The exhaust portion 200 is provided on a middle portion of the substrate 100. The exhaust portion 200 is provided with a plurality of exhaust holes 212, and an area between two adjacent adhesive injection tracks 500 corresponds to at least one of the exhaust holes 212.

The box 600 may be a metal box or a non-metal box. The box 600 is provided with an opening, and the substrate 100 is configured to cover the opening of the box 600, so as to seal the box 600. The substrate 100 may be a metal substrate or a non-metal substrate. For example, the substrate 100 may be of a flat plate structure, and the shape of the substrate 100 may be polygonal. It should be noted that, the specific shape of the substrate 100 may be determined according to the shape of the box 600, that is, the substrate 100 may be flat or may not be flat.

As described above, the box 600 and the substrate 100 together form the accommodating cavity 61. The accommodating cavity 61 is configured to accommodate the plurality of cells 400. The plurality of cells 400 are arranged in an array within the accommodating cavity 61. Specifically, the box 600 is provided with the plurality of adhesive injection tracks 500 in the accommodating cavity 61, so as to define a plurality of accommodating regions 611 in the accommodating cavity 61. Therefore, the plurality of cells 400 may be closely arranged in multiple rows and multiple columns within the plurality of accommodating regions 611 of the accommodating cavity 61. A top end of the cell 400 is arranged adjacent to the substrate 100, and a bottom end of the cell 400 is arranged adjacent to a bottom of the box 600. The top end of the cell 400 can be an electrode output terminal. For example, the cell 400 is a cylindrical lithium-ion cell.

As described above, the accommodating cavity 61 is also configured to accommodate foam adhesive. For example, a foaming machine can be used to output foam adhesive. After the plurality of cells 400 are placed in the accommodating cavity 61, the foam adhesive can be injected, through the foaming machine, into the accommodating cavity 61 along the preset adhesive injection tracks 500, so as to form the foam adhesive along the preset adhesive injection tracks 500 in the accommodating cavity 61, fix the cells 400 in the accommodating cavity 61, and divide the plurality of cells 400 into multiple groups.

For example, the preset adhesive injection tracks 500 may be a plurality of segments of one adhesive injection track, and the foam adhesive is formed along the plurality of adhesive injection tracks 500 in the accommodating cavity 61. The foam adhesive freshly injected into the accommodating cavity 61 is in a liquid state and has fluidity. After the foam adhesive in corresponding adhesive injection track 500 comes into contact with air, the foam adhesive expands, so that the foam adhesive can fill up the gaps among the cells 400, thereby filling up the remaining space in the accommodating cavity 61. It should be noted that, when the time for which the foam adhesive comes into contact with air reaches a preset value, the foam adhesive will solidify to form a solid foam adhesive, thereby fixing each cell 400 in the accommodating cavity 61, preventing the cells 400 from shaking, preventing the cells 400 from being affected by dust, temperature and humidity, reducing the risk of moisture, corrosion and short circuit of the battery, improving the safety of the battery pack 1, and also helping with shock absorption and extending battery life.

The exhaust portion 200 and the substrate 100 are an integrally formed structure. The exhaust portion 200 may be in a long strip shape. For example, an extension direction of the exhaust portion 200 intersects with an extension direction of each adhesive injection track 500. For example, the extension direction of the exhaust portion 200 may be perpendicular to the extension direction of each adhesive injection track 500. The exhaust portion 200 is provided with a plurality of exhaust holes 212, and the plurality of exhaust holes 212 are spaced apart from each other.

By setting the exhaust portion 200 on the middle portion of the substrate 100, and setting the area between two adjacent adhesive injection tracks 500 to correspond to at least one exhaust hole 212, when fully encapsulating and foaming the battery pack 1, the foam adhesive merges towards the middle area between two adjacent adhesive injection tracks 500 from the two adjacent adhesive injection tracks 500, bubbles are gradually squeezed to the middle area, and gas in the bubbles can be effectively discharged through the exhaust holes 212 corresponding to the area between the two adjacent adhesive injection tracks 500, thereby avoiding vacuoles caused by foaming.

In some embodiments, four adhesive injection tracks 500 are provided in the box 600, every four columns of the cells 400 are separated by the adhesive injection tracks 500, and the middle area of two adjacent adhesive injection tracks 500 corresponds to at least one exhaust hole 212. When fully encapsulating and foaming each cell 400 in the box 600, the foam adhesive merges towards the middle area of two adjacent adhesive injection tracks 500 from the two adjacent adhesive injection tracks 500, and the bubbles are gradually squeezed to the middle area between the two adjacent adhesive injection tracks 500, thus, gas in the bubbles and the accommodating cavity 61 can be effectively discharged through the exhaust holes 212 corresponding to the area between the two adjacent adhesive injection tracks 500, thereby preventing bubbles from remaining in the box 600.

It should be noted that, in an open state of the substrate 100, the foam adhesive can be injected into the box 600 through the foaming machine, and after the adhesive injection is completed, the substrate 100 is covered on the opening of the box 600 to seal the box 600. After foaming and expanding in the box 600, the foam adhesive gradually filling the space of the accommodation cavity 61 of the box 600, and gas in the bubbles and the accommodating cavity 61 is discharged through the exhaust holes 212 provided in the exhaust portion 200, thereby effectively discharging the bubbles generated in the box 600 during a foaming process.

In the embodiments of the present disclosure, the box 600 is covered by the substrate 100, the substrate 100 and the box 600 together form the accommodating cavity 61, and the accommodating cavity 61 is configured to accommodate the plurality of cells 400 and the foam adhesive arranged along the plurality of adhesive injection tracks 500. The exhaust portion 200 is provided on the middle portion of the substrate 100. The exhaust portion 200 is provided with the plurality of exhaust holes 212, and the area between two adjacent adhesive injection tracks 500 is set to correspond to at least one exhaust hole 212, so as to discharge gas timely during the fully encapsulating and foaming process of the battery pack 1, thereby preventing bubbles from remaining in the cover structure 10. Specifically, when fully encapsulating and foaming are performed, the foam adhesive merges towards the middle area between two adjacent adhesive injection tracks 500 from the two adjacent adhesive injection tracks 500, and bubbles generated in the box 600 during a foaming process are gradually squeezed to the middle area, and then can be effectively discharged through the exhaust holes 212 corresponding to the area between the two adjacent adhesive injection tracks 500, so as to avoid vacuoles caused by foaming, and improve the adhesive performance of the cover structure 10 and the overall strength of the foam adhesive, thereby enhancing the overall strength of the battery pack 1.

In some embodiments, as shown in FIG. 2, the exhaust portion 200 includes a plurality of exhaust regions 210 arranged at intervals. Each exhaust region 210 is provided with a plurality of exhaust holes 212, and the area between every two adjacent adhesive injection tracks 500 corresponds to at least one of the exhaust holes 212 in each of the exhaust regions 210.

The exhaust region 210 is in a long strip shape. For example, the exhaust region 200 may include four exhaust regions 210 arranged at intervals. For example, the four exhaust regions 210 may be arranged symmetrically based on a central axis X (as shown in FIG. 1) of the substrate 100, and the central axis X of the substrate 100 is perpendicular to the adhesive injection track 500.

The exhaust region 210 is provided with the plurality of exhaust holes 212, and the number of the exhaust holes 212 on the exhaust region 210 may be determined according to the number of the cells 400 in the accommodating cavity 61. For example, every four columns of the cells 400 may be separated by the adhesive injection tracks 500. That is, every four columns of the cells 400 correspond to at least one exhaust hole 212 of each of the exhaust regions 210.

By setting the exhaust portion 200 on the middle portion of the substrate 100, and setting the area between every two adjacent adhesive injection tracks 500 to correspond to at least one exhaust hole 212 of each of the exhaust regions 210, when fully encapsulating and foaming the battery pack 1, the foam adhesive merges towards the middle area between two adjacent adhesive injection tracks 500 from the two adjacent adhesive injection tracks 500, and bubbles are squeezed towards the middle area of the two adjacent adhesive injection tracks 500. Thus, when the bubbles approach the exhaust holes 212, the bubbles can be discharged through the exhaust holes 212. In this way, gas in the bubbles and the accommodating cavity 61 can be effectively discharged through the exhaust holes 212 corresponding to the area between two adjacent adhesive injection tracks 500, thereby avoiding vacuoles caused by foaming. By providing a plurality of exhaust holes 212 at intervals along the extension direction of the adhesive injection tracks 500 between two adjacent adhesive injection tracks 500, due to the displacement of the foam adhesive during the foaming process, bubbles can be discharged from adjacent exhaust holes 212, thereby avoiding bubbles not being discharged in time, thereby effectively improving the discharging efficiency of the bubbles and ensuring that the bubbles can be completely discharged.

For example, the number of the exhaust regions 210 can be determined based on a size of the accommodating cavity 61 of the box 600. For example, for an accommodating cavity of a box with a larger size, the corresponding adhesive injection tracks are longer, and the exhaust portion 200 may be provided with a plurality of exhaust regions 210 arranged at intervals, so that the area between two adjacent adhesive injection tracks 500 corresponds to a plurality of exhaust holes 212 arranged at intervals along the extension direction of the adhesive injection tracks 500. Due to the displacement of the foam adhesive during the foaming process, bubbles can be discharged from adjacent exhaust holes 212, thereby avoiding bubble congestion and failure to discharge in time, thereby effectively improving the discharging efficiency of the bubbles and ensuring that the bubbles can be completely discharged. For an accommodating cavity of a box with a smaller size, the corresponding adhesive injection tracks are shorter, and the exhaust portion 200 may be provided with one exhaust region 210 arranged in the middle portion of the substrate 100. Bubbles are squeezed towards the middle area between two adjacent adhesive injection tracks 500. When the bubbles approach the exhaust holes 212, the bubbles can be discharged through the exhaust holes 212, thereby avoiding vacuoles caused by foaming.

It should be noted that, since the exhaust holes 212 are communicated with the external environment, the sizes of the exhaust holes 212 should not be designed too large or too small. If the exhaust holes 212 is designed too large, it will cause excessive foam adhesive to be discharged from the exhaust holes 212 to the outside, thus affecting the appearance of the product. If the exhaust holes 212 is designed too small, it is easy to cause blockage of the exhaust holes 212, resulting in incomplete discharge of the bubbles inside the box 600.

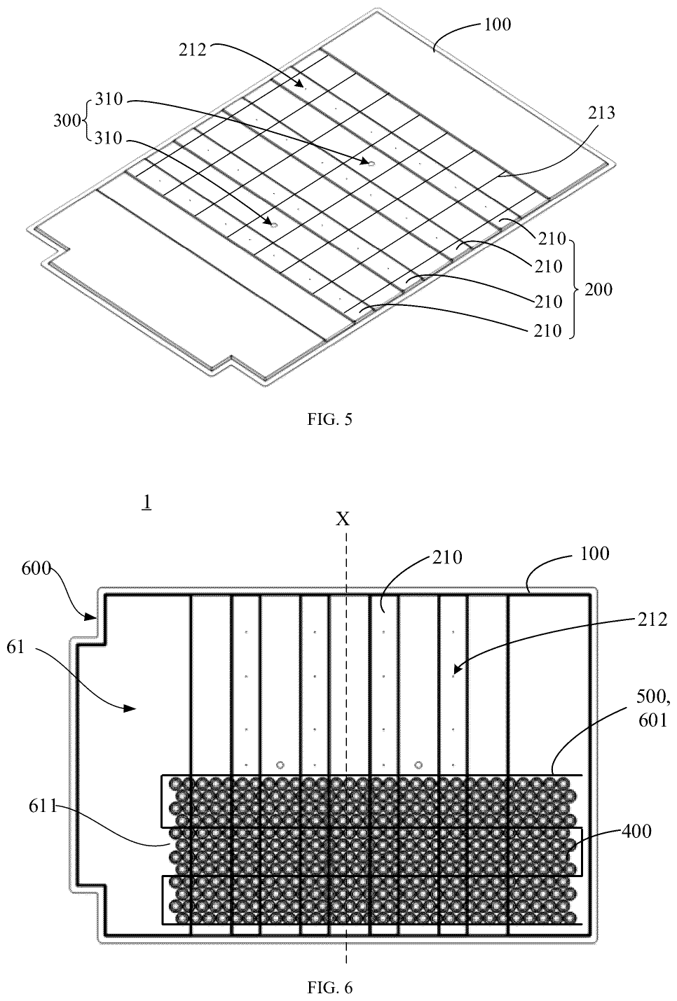

In some embodiments, the box 600 is provided with a plurality of first marking lines 601 corresponding to the adhesive injection tracks 500, and as shown in FIG. 5, the substrate 100 is provided with a plurality of second marking lines 213 corresponding one-to-one with the plurality of first marking lines 601. The area between every two adjacent second marking lines 213 is provided with at least one of the exhaust holes 212 of each of the exhaust regions 210.

In some embodiments, at least one outer side surface of the box 600 is provided with the plurality of first marking lines corresponding one-to-one with the plurality of adhesive injection tracks 500. In this way, when it is necessary to inject adhesive into the box 600, foam adhesive can be injected into the box 600 based on the first marking lines, so that foam adhesive arranged along the preset adhesive injection tracks 500 is formed in the box 600. In another embodiments, as shown in FIG. 6, the plurality of first marking lines 601 may be provided on an outer surface of a bottom of the box 600, and spatially overlap one-to-one with the plurality of adhesive injection tracks 500 along a height direction of the box 600.

The substrate 100 is provided with a plurality of second marking lines 213 arranged in one-to-one correspondence with the plurality of first marking lines. For example, when the substrate 100 covers the box 600, one end of the second marking line 213 can be aligned with one end of the corresponding first marking line. In addition, the plurality of second marking lines 213 further correspond one-to-one with the plurality of adhesive injection tracks 500, when the substrate 100 covers the box 600, the plurality of second marking lines 213 overlap one-to-one with the plurality of adhesive injection tracks 500. It should be noted that, the second marking line 213 may be provided on the substrate 100 by means of silk-screening or engraving, and the first marking line may be provided on the box 600 by means of silk-screening or engraving.

By providing the first marking lines on the box 600, it is convenient for users to inject foam adhesive into the box 600 based on the preset adhesive injection tracks 500. By providing the second marking lines 213 on the substrate 100, it is convenient to match and position the second marking line 213 with a corresponding adhesive injection track 500. When fully encapsulating and foaming the battery pack 1, the foam adhesive merges towards the middle area between two adjacent second marking lines 213 from the two adjacent second marking lines 213, the bubbles are squeezed towards the middle area between the two adjacent second marking lines, and thus when the bubbles approach the exhaust holes 212, the bubbles can be discharged through the exhaust holes 212, thereby avoiding vacuoles caused by foaming.

In some embodiments, the distance between the exhaust region 210 and the bottom of the box 600 is greater than the distance between the substrate 100 and the bottom of the box 600.

For example, the exhaust region 210 may protrude from the substrate 100, so that the distance between the exhaust region 210 and the bottom of the box 600 is greater than the distance between the substrate 100 and the bottom of the box 600. That is, the height of the exhaust region 210 relative to the box 600 is greater than the height of the substrate 100 relative to the box 600, so that the exhaust holes 212 of the exhaust region 210 are located at the highest position of the substrate 100. When fully encapsulating and foaming the battery pack 1, the foam adhesive merges towards the middle area between two adjacent adhesive injection tracks 500 from the two adjacent adhesive injection tracks 500, the bubbles are gradually squeezed to the middle area. In this way, by setting the exhaust holes 212 corresponding to the area between two adjacent adhesive injection tracks 500, and on the basis that the exhaust holes 212 are located at the highest position of the substrate 100, so that the bubbles generated in the box during a foaming process can be effectively discharged, thereby avoiding vacuoles caused by foaming, improving the adhesive performance of the cover structure 100 and the overall strength of the foam adhesive, and then enhancing the overall strength of the battery pack 1.

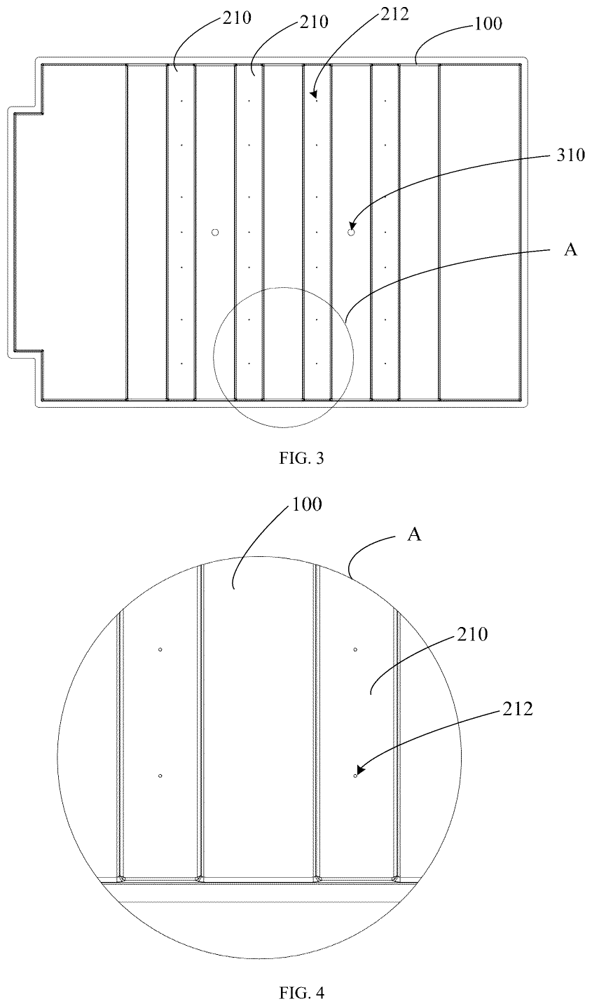

In some embodiments, as shown in FIGS. 3 and 4, the plurality of exhaust holes 212 in the same exhaust region 210 are arranged at equal intervals.

For example, if eight adhesive injection tracks 500 are arranged in the accommodating cavity 61, then each of the exhaust region 210 is provided with seven exhaust holes 212, and there is one exhaust hole 212 of each exhaust region 210 corresponding to the area between two adjacent adhesive injection tracks 500. For example, every four columns of the cells 400 are separated by the adhesive injection tracks 500, by arranging the plurality of exhaust holes 212 of the same exhaust region 210 at equal intervals, each of the exhaust holes 212 of the exhaust region 210 can correspond to the middle positions between two adjacent adhesive injection tracks 500. When fully encapsulating and foaming the plurality of cells 400 in the box 600, the foam adhesive merges towards the middle area between two adjacent adhesive injection tracks 500 from the two adjacent adhesive injection tracks 500, and the bubbles are gradually squeezed to the middle area between the two adjacent adhesive injection tracks 500. In this way, gas in the bubbles and the accommodating cavity 61 can be effectively discharged through the exhaust holes 212 corresponding to the area between two adjacent adhesive injection tracks 500, thereby preventing the bubbles from remaining in the box 600, and then improving the adhesive performance of the cover structure 10 and the overall strength of the foam adhesive.

For example, as shown in FIG. 1, the plurality of exhaust holes 212 in the same exhaust region 210 are arranged along the same central axis X, and the central axis X is perpendicular to the adhesive injection track 500.

For example, the adhesive injection track 500 may be in a straight line shape, and the plurality of adhesive injection tracks 500 are sequentially communicate (as shown in FIG. 6). The plurality of exhaust holes 212 in the same exhaust region 210 have the same size and shape. For example, the exhaust holes 212 may be circular holes. The center axis X may be a center long axis of the exhaust region 210. The center axis X overlaps a connecting line of center points of the plurality of exhaust holes 212.

The plurality of exhaust holes 212 in the same exhaust region 210 are arranged along the same central axis X, and the central axis X is perpendicular to the adhesive injection track 500. Each exhaust hole 212 corresponds to the middle position between the two adjacent adhesive injection tracks 500. When fully encapsulating and foaming the cells in the box, the foam adhesive merges towards the middle area between two adjacent adhesive injection tracks 500 from the two adjacent adhesive injection tracks 500, and the bubbles are gradually squeezed to the middle area of the two adjacent adhesive injection track 500. In this way, gas in the bubbles and the accommodating cavity 61 can be effectively discharged through the exhaust holes 212 corresponding to the area between the two adjacent adhesive injection tracks 500, thereby preventing the bubbles from remaining in the box 600, so as to improve the adhesive performance of the cover structure 10 and the overall strength of the foam adhesive. In addition, a simplified design of the cover structure 10 is realized, inner cross beams of the box 600 can be reduced, the wall thickness of the box is thinned, the number of corresponding fasteners can also be reduced, the weight of the battery pack 1 is reduced, the energy density of the battery pack 1 can also be improved, and the costs are reduced.

In one embodiment, as shown in FIGS. 3 and 4, the width of the exhaust region 210 is less than the spacing distance between two adjacent exhaust regions 210.

For example, the exhaust region 210 is provided as a convex structure, so that the relative height of the exhaust region 210 is greater than the relative height of the substrate 100. In addition, the width of the exhaust region 210 is set to be smaller than the distance between two adjacent exhaust regions 210, thus, when fully encapsulated and foamed is performed in the box 600, the foam adhesive merges towards the middle area between two adjacent adhesive injection tracks 500 from the two adjacent adhesive injection tracks 500, so that the bubbles are gradually squeezed to the exhaust region 210, and then the bubbles are discharged through the exhaust holes 212 in the exhaust region 210. Thus, the bubbles generated in the box 600 during a foaming process can be effectively discharged through the exhaust holes 212 corresponding to the area between two adjacent adhesive injection tracks 500, thereby avoiding vacuoles caused by foaming, improving the adhesive performance of the cover structure and the overall strength of the foam adhesive, and then enhancing the overall strength of the battery pack 1.

In one embodiment, the aperture of the exhaust hole 212 is between 3 mm and 6 mm (millimeters). The aperture of the exhaust hole 212 refers to the diameter of the exhaust hole 212. For example, the aperture of the exhaust hole 212 may be 3 mm, 5 mm, or 6 mm.

By setting the diameter of the exhaust holes 212 between 3 mm and 6 mm, when the plurality of cells 400 in the box are fully encapsulated and foamed, the foam adhesive merges towards the middle area between two adjacent adhesive injection tracks 500 from the two adjacent adhesive injection tracks 500, and bubbles are slowly squeezed to the middle area of the two adjacent adhesive injection tracks 500. In this way, the bubbles generated in the box during a foaming process can be effectively discharged through the exhaust holes 212 corresponding to the area between two adjacent adhesive injection tracks 500, thereby avoiding blockage of the exhaust holes 212 caused by the exhaust holes 212 being too small and unable to discharge the bubbles in time, and also avoiding the discharge of foam adhesive caused by the exhaust holes 212 being too large, effectively improving the adhesive performance of the cover structure 10 and the overall strength of the foam adhesive, and then enhancing the overall strength of the battery pack 1.

In some embodiments, as shown in FIGS. 2 and 3, the cover structure 10 further includes a fixing portion 300. The fixing portion 300 is provided on the substrate 100, and the fixing portion 300 is provided with a plurality of fixing holes 310.

The fixing portion 300 may be provided with two fixing holes 310 arranged at intervals. For example, a fastening member (such as a bolt) may penetrate through the fixing holes 310, to lock the substrate 100 on the box 600, so that the substrate 100 is installed on the box 600, thereby simplifying the structure of the cover structure 10, reducing inner cross beams of the box 600, eliminating the need for excessive fasteners, reducing the weight of the battery pack 1, improving the energy density of the battery pack 1, and reducing the cost.

In the embodiments of the present disclosure, the box is covered by the substrate, the substrate and the box together form the accommodating cavity, and the accommodating cavity is configured to accommodate the plurality of cells and the foam adhesive arranged along the plurality of adhesive injection tracks. The exhaust portion is provided on the middle portion of the substrate. The exhaust portion is provided with the plurality of exhaust holes, and the area between two adjacent adhesive injection tracks is set to correspond to at least one exhaust hole, so as to discharge gas timely during the fully encapsulating and foaming process of the battery pack, thereby preventing bubbles from remaining in the cover structure. Specifically, when fully encapsulating and foaming are performed, the foam adhesive merges towards the middle area between the two adjacent adhesive injection tracks from the two adjacent adhesive injection tracks, and bubbles generated in the box during a foaming process are gradually squeezed towards the middle area, and then can be effectively discharged through the exhaust holes corresponding to the area between the two adjacent adhesive injection tracks, so as to avoid vacuoles caused by foaming, and improve the adhesive performance of the cover structure and the overall strength of the foam adhesive, thereby enhancing the overall strength of the battery pack.

It should be noted that the battery pack may also include components such as output electrodes. A specific battery pack may include more components than those described in the embodiments of the present disclosure, or combine some components, or have different component arrangements.

What is claimed is:

1. A cover structure employed in a battery pack, the battery pack further comprising a plurality of cells and a box; the cover structure comprising:
a substrate configured to cover the box; wherein the substrate and the box together form an accommodating cavity, and the accommodating cavity is configured to accommodate the plurality of cells and foam adhesive arranged along a plurality of adhesive injection tracks preset in the accommodating cavity; and
an exhaust portion provided on a middle portion of the substrate; the exhaust portion is provided with a plurality of exhaust holes; wherein an area between two adjacent adhesive injection tracks corresponds to at least one of the exhaust holes.

2. The cover structure according to claim 1, wherein the exhaust portion comprises a plurality of exhaust regions arranged at intervals; wherein each exhaust region is provided with a plurality of exhaust holes, and the area between every two adjacent adhesive injection tracks corresponds to at least one of the exhaust holes in each of the exhaust regions.

3. The cover structure according to claim 2, wherein a distance between the exhaust region and a bottom of the box is greater than a distance between the substrate and the bottom of the box.

4. The cover structure according to claim 2, wherein the plurality of exhaust holes in the same exhaust region are arranged at equal intervals.

5. The cover structure according to claim 4, wherein the plurality of exhaust holes in the same exhaust region are arranged along a central axis of the substrate; wherein the central axis is perpendicular to the adhesive injection track.

6. The cover structure according to claim 4, wherein a width of the exhaust region is less than a spacing distance between two adjacent exhaust regions.

7. The cover structure according to claim 1, wherein the exhaust hole is a circular hole.

8. The cover structure according to claim 7, wherein an circular of the exhaust hole is between 3 mm and 6 mm.

9. The cover structure according to claim 2, wherein the exhaust region is in a long strip shape, and an extension direction of the exhaust portion intersects with an extension direction of the adhesive injection track.

10. The cover structure according to claim 9, wherein the box is provided with a plurality of first marking lines corresponding one-to-one with the adhesive injection tracks; the substrate is provided with a plurality of second marking lines corresponding one-to-one with the first marking lines; wherein the area between every two adjacent second marking lines is provided with at least one of the exhaust holes of each of the exhaust regions.

11. The cover structure according to claim 10, wherein the plurality of second marking lines overlap one-to-one with the plurality of adhesive injection tracks when the substrate covers the box.

12. The cover structure according to claim 1, further comprising a fixing portion, wherein the fixing portion is provided on the substrate; the fixing portion is provided with a plurality of fixing holes for locking the substrate on the box.

13. The cover structure according to claim 3, wherein the exhaust region is protrude from the substrate.

14. A battery pack, comprising:
a plurality of cells;
a box; and
a cover structure comprising:
a substrate configured to cover the box; wherein the substrate of the cover structure and the box together form an accommodating cavity; wherein the box is preset with a plurality of adhesive injection tracks in the accommodating cavity; the accommodating cavity is configured to accommodate the plurality of cells and foam adhesive arranged along a plurality of adhesive injection tracks; and
an exhaust portion provided on a middle portion of the substrate; the exhaust portion is provided with a plurality of exhaust holes; wherein an area between two adjacent adhesive injection tracks corresponds to at least one of the exhaust holes.

15. The battery pack according to claim 14, wherein the plurality of adhesive injection tracks are sequentially communicate.

16. The battery pack according to claim 14, wherein the exhaust portion comprises a plurality of exhaust regions arranged at intervals; wherein each exhaust region is provided with a plurality of exhaust holes, and the area between every two adjacent adhesive injection tracks corresponds to at least one of the exhaust holes in each of the exhaust regions.

17. The battery pack according to claim 16, wherein a distance between the exhaust region and a bottom of the box is greater than a distance between the substrate and the bottom of the box.

18. The battery pack according to claim 16, wherein the exhaust region is in a long strip shape, and an extension direction of the exhaust portion intersects with an extension direction of the adhesive injection track.

19. The battery pack according to claim 18, wherein the box is provided with a plurality of first marking lines corresponding one-to-one with the adhesive injection tracks; the substrate is provided with a plurality of second marking lines corresponding one-to-one with the plurality of first marking lines; wherein the area between every two adjacent second marking lines is provided with at least one of the exhaust holes of each of the exhaust regions.

20. The battery pack according to claim 19, wherein the plurality of second marking lines overlap one-to-one with the plurality of adhesive injection tracks when the substrate covers the box.
